(19) United States
(12) Patent Application Publication
(10) Pub. No.: US 2025/0298678 A1
(43) Pub. Date: Sep. 25, 2025

(54) METHOD FOR LAUNCHING APPLICATION, LAUNCH SYSTEM, AND NON-TRANSITORY COMPUTER-READABLE MEDIUM STORING LAUNCH PROGRAM CODE

(71) Applicant: Rakuten Group, Inc., Tokyo (JP)

(72) Inventors: Daiki ENDO, Tokyo (JP); Kenji Fukui, Tokyo (JP)

(73) Assignee: Rakuten Group, Inc., Tokyo (JP)

(21) Appl. No.: 19/081,082

(22) Filed: Mar. 17, 2025

(30) Foreign Application Priority Data
Mar. 22, 2024 (JP) 2024-046487

(51) Int. Cl. G06F 9/54; G06F 9/445; G06Q 20/32; H04W 4/029

(52) U.S. Cl. CPC G06F 9/542; G06F 9/445; G06Q 20/3272; H04W 4/029

(57) ABSTRACT

A method for launching an application installed on a mobile terminal is provided. The mobile terminal includes a location sensor and a signal receiver switchable between an enabled state and a disabled state. The method includes acquiring a current location of the mobile terminal, acquiring store information that includes a store location, upon detecting that the mobile terminal has approached the store based on the store location and the current location, enabling the signal receiver in the disabled state, and, when the signal receiver receives the signal that is transmitted within the store, automatically launching the application.

### CROSS-REFERENCE TO RELATED APPLICATIONS

This application is based upon and claims the benefit of priority from Japanese Patent Application No. 2024-046487, filed on Mar. 22, 2024, the entire contents of which are incorporated herein by reference.

### BACKGROUND

### 1. Field

The present disclosure relates to a method for launching an application, a launch system, and a non-transitory computer-readable medium storing a launch program code.

There are multiple methods for cashless payment. Japanese Laid-Open Patent Publication No. 2015-211379 discloses an example of a near-field communication (NFC) service application that utilizes an NFC applet for short-range wireless communication. The NFC applet is a program that runs on a subscriber identity module (SIM) mounted on a mobile terminal.

The NFC applet provides a card emulation feature that emulates payment cards (e.g., credit cards or electronic money cards). By registering credit card information in the NFC service application, a user uses the mobile terminal as a substitute for a credit card to perform cashless payments.

The above-described program is configured to manage the enabled and disabled states of the NFC applet such that the NFC service application is available only when predefined usage conditions are satisfied, even without user intervention. The use of this program eliminates the need for users to manually enable or disable the NFC applet, thereby simplifying user operations.

Other cashless payment methods include code-based payment. Several business entities offer code-based payment services. Each business entity supplies its own code-based payment application. After purchasing a mobile terminal, a user installs one or more payment applications on the mobile terminal. For instance, in the store-scan method of code-based payment, the user manually performs operations (e.g., launches the payment application used for payment to display the payment screen).

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Even within the same payment application, the operational methods differ between NFC service applications and code-based payment applications during use. Further, the operational methods of applications vary depending on their type, not limited to payment applications. Therefore, technology to simplify manual operations performed by users is required according to the application.

It is an object of the present disclosure to provide an application launching method for simplifying manual operations for an application installed on a mobile terminal, a launch system, and a non-transitory computer-readable medium storing a launch program code will now be described with reference to the drawings.

An aspect of the present disclosure provides a method for launching an application installed on a mobile terminal. The mobile terminal includes a location sensor configured to acquire a current location of the mobile terminal and a signal receiver configured to receive a signal. The signal receiver is switchable between an enabled state and a disabled state. The method includes acquiring the current location of the mobile terminal, acquiring store information related to a store, the store information including a store location, upon detecting that the mobile terminal has approached the store based on the store location and the current location, enabling the signal receiver in the disabled state, and, when the signal receiver receives the signal that is transmitted within the store, automatically launching the application.

An aspect of the present disclosure provides a launch system. The launch system includes a signal transmitter configured to transmit a signal within a store, a mobile terminal with an application installed, the mobile terminal including a location sensor configured to acquire a current location of the mobile terminal and a signal receiver configured to receive the signal, and a server configured to send store information related to the store to the mobile terminal, the store information including a store location. The mobile terminal is configured to execute acquiring the current location using the location sensor, acquiring the store information through communication with the server, upon detecting that the mobile terminal has approached the store based on the store location and the current location, enabling the signal receiver in a disabled state, and, when, the signal receiver receives the signal within the store, automatically launching the application.

An aspect of the present disclosure provides a non-transitory computer-readable medium storing a launch program code for launching an application installed on a mobile terminal. The mobile terminal includes a location sensor configured to acquire a current location of the mobile terminal and a signal receiver configured to receive a signal. The signal receiver is switchable between an enabled state and a disabled state. The launch program code includes current location acquisition code configured to acquire the current location of the mobile terminal, store information acquisition code configured to acquire store information related to a store, the store information including a store location, enabling code configured to, upon detecting that the mobile terminal has approached the store based on the store location and the current location, enable the signal receiver in the disabled state, and automatic launch code configured to, when the signal receiver receives the signal that is transmitted within the store, automatically launch the application.

Other features and aspects will be apparent from the following detailed description, the drawings, and the claims.

### BRIEF DESCRIPTION OF THE DRAWINGS

FIG. 1 is a schematic diagram illustrating the configuration of a launch system according to an embodiment.

FIG. 2 is a block diagram illustrating the electrical configuration of a computer.

FIG. 3 is a block diagram illustrating the electrical configuration of the mobile terminal of the embodiment.

FIG. 4 is an illustration showing a switchable display screen of the payment application.

FIG. 5 is a schematic diagram illustrating the configuration of a customer visit detection system.

FIG. 6 is an illustration showing a list screen of the check-in application.

FIG. 7 is a flowchart illustrating the method for launching the application.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

Examples of a method for launching an application installed on a mobile terminal, a launch system, and a non-transitory computer-readable medium storing a launch program code for an application will now be described with reference to the drawings. The scope of the present disclosure is defined not by the detailed description but by the claims and their equivalents, and all variations within the scope of the claims and their equivalents are to be construed as being included in the disclosure.

### Overall Configuration

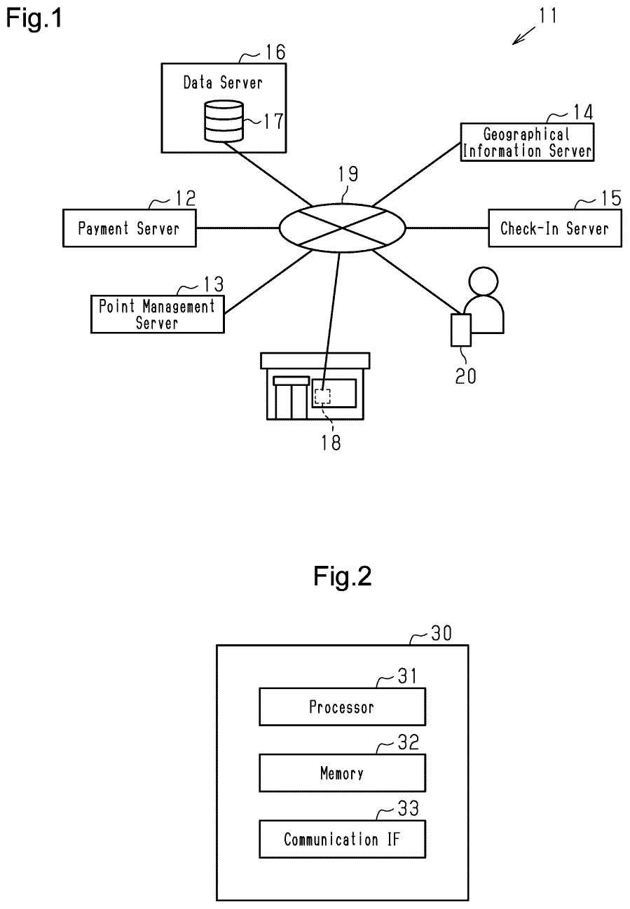

As shown in FIG. 1, a launch system 11 may include one or more servers. The one or more servers may include at least one of a payment server 12, a point management server 13, a geographic information server 14, a check-in server 15, and a data server 16. The data server 16 may include a database 17. Two or more of the servers 12 to 16 may be integrated into a single computer or server. The database 17 may be held, either partially or totally, by at least one of the servers 12 to 15, instead of or in addition to the data server 16.

The servers 12 to 16, one or more mobile terminals 20, and one or more store terminals 18 may be capable of communicating with each other via the network 19. The mobile terminal 20 is a user terminal that is used by users. The mobile terminal 20 may be, but is not limited to, a tablet, a smartphone, or a smartwatch. The store terminal 18 is installed in stores. At least one of the one or more mobile terminals 20 and the one or more store terminals 18 may be included in the launch system 11.

Examples of the network 19 include the Internet, a wide area network (WAN), a local area network (LAN), a provider terminal, a wireless communication network, a wireless base station, and a dedicated line. However, not all combinations of the servers 12 to 16, the mobile terminal 20, and the store terminal 18 depicted in FIG. 1 are required to be capable of communicating with each other.

FIG. 2 illustrates a basic configuration of a computer 30, which serves as an example of the servers 12 to 16. The computer 30 includes, for example, one or more processors 31, one or more memories 32, and a communication interface (IF) 33. The communication interface 33 enables communication with other devices via the network 19. The servers 12 to 16 may each have a different configuration.

The processor 31 is, for example, a central processing unit (CPU), a graphics processing unit (GPU), a microprocessor unit (MPU), a field-programmable gate array (FPGA), or any other arithmetic unit. The processor 31 is processing circuitry configured to execute various types of software processing. The processing circuitry may include a dedicated hardware circuit (e.g., ASIC) used to process at least part of the software processing. That is, the software processing may be executed by processing circuitry including at least one of a set of one or more software processing circuits and a set of one or more dedicated hardware circuits.

The memory 32 is a non-transitory computer-readable medium. The memory 32 may include, for example, a random-access memory (RAM) or another type of a volatile memory. The memory 32 may be configured to temporarily store programs and data. The memory 32 may include a storage that permanently stores data including programs. The program permanently stored in the memory 32 may include an operating system (OS) for controlling the overall operation of the computer and applications for executing specific operations.

The storage may be, for example, a read-only memory (ROM), a hard disk device, a flash memory, or any other non-volatile storage device. The storage may be a removable storage device (e.g., a memory card). The communication interface 33 may be, for example, implemented as a LAN or another type of wired communication IF.

### Mobile Terminal

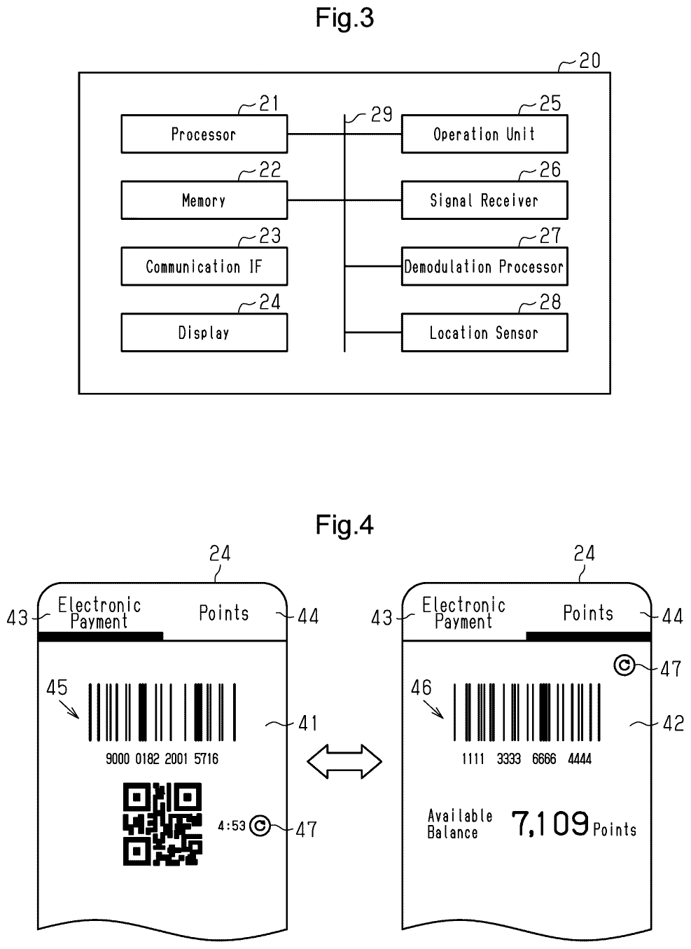

FIG. 3 illustrates the electronic configuration of the mobile terminal 20. The mobile terminal 20 includes at least one processor 21, at least one memory 22, and a communication interface 23. The configurations of the processor 21, the memory 22, and the communication interface 23 may be the same as those of the processor 31, the memory 32, and the communication interface 33.

The memory 22 stores various programs. The programs include an operating system (OS) to control the overall operation of the mobile terminal 20 and applications to execute specific functions. Hereinafter, the application stored in memory 22 may be referred to as the app.

The mobile terminal 20 may include a display 24, an operation unit 25, a signal receiver 26, a demodulation processor 27, and a location sensor 28. The processor 21, the memory 22, the communication interface 23, the display 24, the operation unit 25, the signal receiver 26, the demodulation processor 27, and the location sensor 28 are connected to each other via a communication bus 29 to enable communication therebetween. The operation unit 25 is an input device. If the display 24 is a touch panel, the operation unit 25 may include a touch sensor.

The signal receiver 26 may be switchable between an enabled state and a disabled state. The signal receiver 26 is configured to receive a signal that includes at least one of an audio signal, an ultrasonic signal, and a short-range wireless signal. The signal receiver 26 may be a microphone built into the mobile terminal 20 as a standard feature for voice calls or voice control. The microphone is used as an input device for receiving a sound. The signal receiver 26 may be configured to receive sound waves including ultrasonic waves, in addition to or instead of audible-range sounds. The sound waves received by the signal receiver 26 are first converted into electrical signals and then demodulated by the demodulation processor 27.

The signal receiver 26 may be configured to receive signals for short-range wireless communication. Examples of the short-range wireless communication method may include, but are not limited to, Bluetooth® or ultra-wideband (UWB).

The location sensor 28 is configured to acquire the current location of the mobile terminal 20. The location sensor 28 may be configured to detect the location of the mobile terminal 20 using a satellite positioning system. Examples of the location sensor 28 may include a global positioning system (GPS) module. The GPS module is a receiver that receives signals from satellites. The location sensor 28 is configured to, for example, receive signals from three to four satellites and detect the current location of the mobile terminal 20 based on the received signals.

The location sensor 28 may be another type of satellite positioning sensor, such as a global navigation satellite system (GNSS) as an alternative to or in addition to the GPS module. Alternatively, the location sensor 28 may include a sensor or unit that utilizes an inertial measurement unit or UWB technology.

### Electronic Payment Services and Point Program

The payment server 12 is configured to provide electronic payment services, such as code-based payment. The point management server 13 is configured to provide various services related to a universal point program. For example, the point management server 13 is configured to execute various processes for the management of points, granting of points, and exchange of points for rewards.

At least some stores are electronic payment-enabled stores, which provide electronic payment services. At least some stores are point program-participating stores that participate in a universal point program. At least some electronic payment-enabled stores are point program-participating stores. When a user makes a payment at a point program-participating store, points are generally awarded to the user based on the payment amount.

In this example, a point program designed to provide rewards to users is referred to as a loyalty program. The accumulation of points is represented as the number of points. The unit of exchange for redeeming rewards is not limited to points. The unit may be changed to another name such as, miles, money coins, dollars, stamps, or cash.

Service business entities that offer electronic payment services manage one or more store terminals 18 used in each store. The store terminals 18 are configured to communicate with the payment server 12 via the network 19. The store terminal 18 may be, but is not limited to, a computer, a POS terminal, or a portable device.

Users include at least one user who uses only one of the electronic payment service and the point program and at least one user who uses both. The mobile terminal 20 of a user participating in the point program may have a point management application (hereinafter referred to as a point app) installed to manage points.

A payment application (hereinafter referred to as a pay app) is installed on the mobile terminal 20 of a user who uses electronic payment services. The pay app may include a point management feature to handle points. This allows the user to manage points using the pay app on the mobile terminal 20 without installing a point app.

As shown in FIG. 4, the pay app may be capable of switching the display 24 between a payment screen 41 for performing a payment and a point management screen 42 for handling points. Switching between the payment screen 41 and the point management screen 42 may be performed by operating a payment tab 43 and a point tab 44, respectively. The payment screen 41 may be a code display screen 41 for code-based payment.

The point management screen 42 may also serve as a code display screen 42 for user authentication. The point management screen 42 may be displayed for the allocation of points associated with payment. The point management screen 42 may be displayed for payment using points (hereinafter referred to as point-based payment). The point management screen 42 may display the number of points held by the user. When launched by the user, the point app displays a point management screen (code display screen) 42 similar to that of the pay app.

The code display screens 41 and 42 respectively include one or more identification codes 45 and 46. The identification codes 45 and 46 may be a multi-digit character string that includes at least one of a number, a character, or a symbol. The identification codes 45 and 46 may be two-dimensional codes that encode this character string. The two-dimensional codes may be, but is not limited to, a barcode or a QR code®. The code display screens 41 and 42 may include a reload button 47.

The identification codes 45 and 46 are user codes that include user identification information used to identify a user. The identification codes 45 and 46 may further include payment identification information used to identify a payment process. Each time the code display screens 41 and 42 are displayed, new identification codes 45 and 46 may be generated. The identification codes 45 and 46 may be regenerated by operating the reload button 47, and may have a valid time (for example, five minutes).

The user may wish to use payment methods other than code-based payment using the code display screen 41, such as cash payment, credit card payment, or point-based payment. In this case, instead of using the code display screen 41, the user presents the point management screen 42 before payment. This allows the user to make point-based payment and earn points corresponding to the payment amount.

The user can manage points using a point management feature of the pay app or point app. Point management includes, for instance, checking the balance of accumulated points, reviewing the history of earning points, redeeming points for rewards, and checking the history of point redemptions.

The database 17 may include a store database and a user database. The store database stores various types of information related to point program-participating stores, electronic payment-enabled stores, and the store terminal 18. Store information related to a store includes information indicating whether the store is a point program-participating store and information indicating whether the store is an electronic payment-enabled store. Examples of the store information include, but are not limited to, the store name, store ID, location, account, email address, authentication information, payment recipient account, terminal ID for the store terminal 18, electronic payment history, and points awarding history.

The user database stores various types of information related to users who use electronic payments. Examples of user information related to a user include, but are not limited to, the user name, user ID, address, account, email address, electronic payment history, point acquisition history, and point usage history. Examples of the payment information include credit card numbers, debit card numbers, and direct debit account numbers. The user database may include purchase history and payment history of each user.

Examples of the payment history and purchase history include, but are not limited to, the name of the store where a payment was made, the date and time when a payment was made, the items that were purchased in association with a payment, and a purchase amount.

### Customer Detection System and Check-in Service

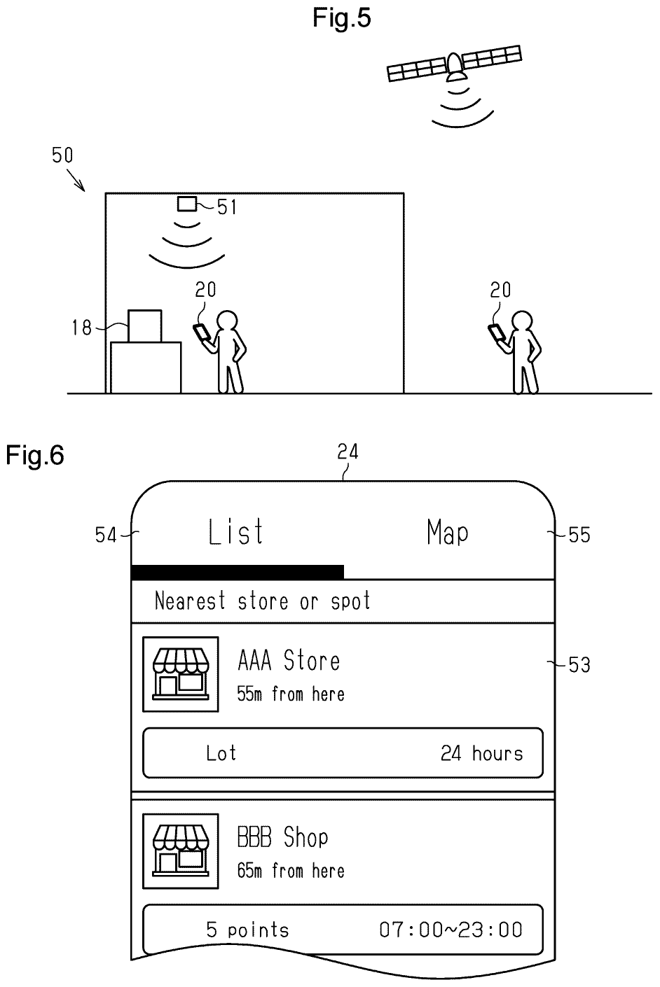

As shown in FIG. 5, a customer visit detection system 50 may include the check-in server 15 (see FIG. 1) and one or more signal transmitters 51. The customer visit detection system 50 may be included in the launch system 11. The customer visit detection system 50 is used to detect the visit of a user within a pre-registered store via the mobile terminal 20. The registered stores that can use the customer visit detection system 50 may be registered in the store database.

The signal transmitter 51 is configured to transmit signals within a store. The signal transmitter 51 may be a beacon, an ultrasonic wave generator that emits ultrasonic waves, or a device that transmits short-range wireless communication (e.g., Bluetooth or UWB) signals. These signals can be received by the signal receiver 26 of the mobile terminal 20. The signal transmitter 51 can be installed in one or more locations within the store (e.g., at the entrance, on the ceiling, or relatively near the cash register).

A check-in application (hereinafter referred to as an check-in app) may be installed on the mobile terminal 20. The check-in app is provided to users who use the check-in service.

The check-in service is generally provided to encourage users to visit stores. In the check-in service, the check-in server 15 is notified of the visit of the user at a predetermined registered store. As a result, the user receives rewards, such as points.

When using the check-in service, the user first launches the check-in app. When the check-in application is launched, the location sensor 28 acquires the location information of the mobile terminal 20. Additionally, the check-in application retrieves information related to one or more registered stores located in the vicinity of the current location of the mobile terminal 20 from the check-in server 15.

FIG. 6 illustrates a list screen 53 that is displayed by the check-in app. The list screen 53 displays one or more registered stores that are located relatively near the mobile terminal 20. In this case, for some or all of the registered stores, the proximity required for them to be considered nearby and displayed on the list screen 53 may be registered as the store information in the database 17. The target range may be set, for example, based on the trade area of the registered store. For example, the target range of a convenience store may be narrower than that of a large-scale commercial facility. The target range may be defined by a distance and, for example, may be several kilometers (e.g., two to five kilometers).

The list screen 53 may include a list tab 54 and a map tab 55. When the user operates the list tab 54, the list screen 53 shown in FIG. 6 is displayed. When the user operates the map tab 55, a map screen (not shown) is displayed. In this screen, the location information of the mobile terminal 20 and registered stores nearby are plotted. When the user selects one of the registered stores displayed on the list screen 53 or the map screen, detailed information of the selected registered store is shown along with a detection button.

The user views the list screen 53 or the map screen to move into a specific registered store. When the user operates the detection button, the check-in app displays a detection screen (not shown) that detects a signal. In response to the operation of the detection button, the check-in app enables the signal receiver 26 of the mobile terminal 20.

The signal transmitted from the signal transmitter 51 can typically only be received when entering the registered store. When the activated signal receiver 26 detects a signal within the registered store, the check-in app displays a check-in button on the display 24. When the user operates the check-in button, the check-in app sends the user information to the check-in server 15. This allows the check-in server 15 to record the user's visit to the store in the database 17. This process, in which a user visiting a store leaves a visit record, is referred to as check-in. The check-in process of this example is performed through such manual operations by users.

Instead of the user manually performing a check-in operation, the check-in app may send the user information to the check-in server 15 upon receiving a signal. Such an automatic transmission of user information may be implemented by the user configuring a setting for the check-in app to permit the use of location information or automatic check-in operations.

### Launch Program and Launch Method

In the mobile terminal 20, if the signal receiver 26 is constantly operating, the battery capacity will deplete quickly. Therefore, the signal receiver 26 is designed to switch its operating state between ON (i.e., an enabled state) and OFF (i.e., a disabled state). To reduce the power consumption of the mobile terminal 20, users often turn off the signal receiver 26 when it is not being used for the intended purpose. To activate the signal receiver 26, the user manually enables the signal receiver 26 in an attempt to receive a signal. Alternatively, when the user manually launches an app that utilizes the signal receiver 26, the app enables the signal receiver 26.

Typically, for a user to perform a check-in operation upon entering a store, the user is required to manually launch the check-in app. Similarly, for a user to perform the code display screen 41 or 42, the user is required to manually launch the point app or pay app. If users find launching these apps bothersome, there is a risk that the frequency of application usage will decrease. To eliminate the need for manually launching the apps, the launch program includes instructions for automatically launching the apps.

Specifically, the program stored in the memory 22 of the mobile terminal 20 includes an application installed on the mobile terminal 20 and a launch program to automatically launch the application. The launch program is configured to be executed by one or more processors 21.

The application that is automatically launched by the launch program is also referred to as a launch target app. Typically, the launch target app requires the user to manually launch it such that a specific screen (e.g., the code display screen 41 or 42) is then displayed. Examples of the launch target app include, but are not limited to, the check-in app, the point app, or the payment app.

The launch program may be included in the launch target app or may be a launch application that is different from the launch target app. The launch application may allow one or more launch target apps that should automatically launch to be selectively set from multiple launch target apps (e.g., the check-in app, the point app, or the payment app).

The automatic launching of such apps may allow the user to configure whether execution is permitted within the app. If the automatic launch configuration of the app is enabled, the processor 21 executes an automatic launch process, which will be described below. If the automatic launch configuration of the app is disabled, the processor 21 does not execute the automatic launch process.

The store that allows the launch program to operate is referred to as the target store. The target store is, for example, a store where the signal transmitter 51 is installed. The geographic information server 14 may be configured to manage store information related to one or more target stores along with map data. The one or more target stores may include registered stores for the check-in service. Further, the one or more target stores may include point program-participating stores and electronic payment-enabled stores. The geographic information server 14 may retrieve store information from the database 17.

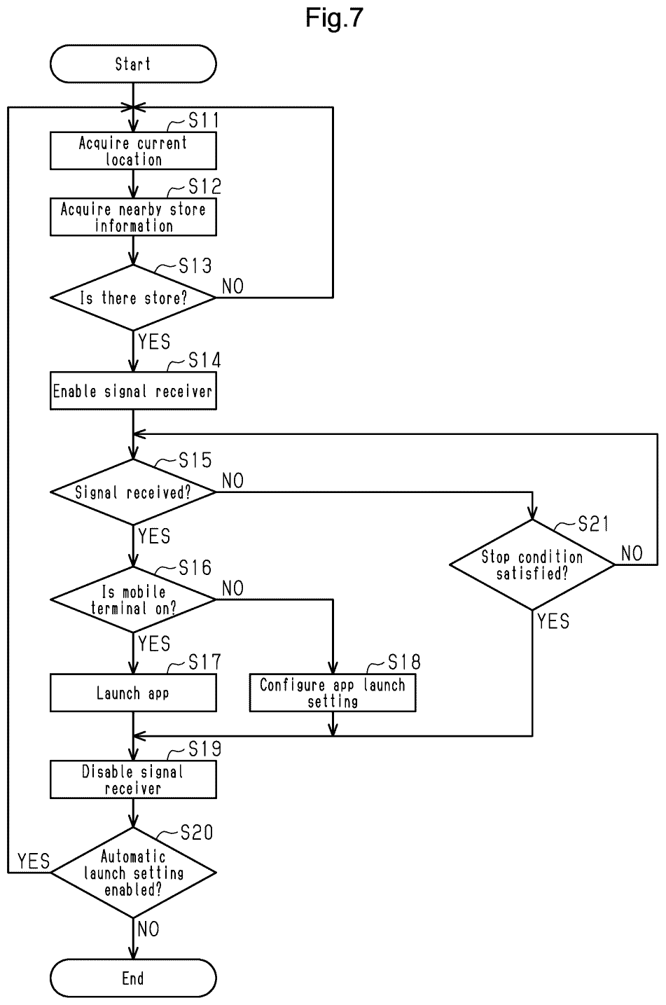

The sequence of processes executed by the processor 21 when the automatic launch setting is enabled will now be described with reference to FIG. 7. The launch program contains instructions for executing steps S11 to S21.

First, in step S11, the processor 21 acquires the current location of the mobile terminal 20 based on the detection results from the location sensor 28, for example, in a first predetermined interval. In step S12, the processor 21 acquires store information of target stores in the vicinity of the current location from the geographic information server 14. The store information includes a target store location, which is the location information of a target store.

The store information may include the detection range of a target store. The detection range is set to determine whether the target store is located relatively near the mobile terminal 20. The detection range is narrower than the target range. The detection range may be defined by a detection distance. The detection distance depends on the detection accuracy of the location sensor 28. For example, the detection distance may be several meters (two to five meters). The detection distance is from the current location of the mobile terminal 20 to the target store, and acts as a trigger for enabling the signal receiver 26.

In step S13, the processor 21 determines whether a target store is located relatively near the mobile terminal 20 based on the detection range of the target store. Specifically, the processor 21 determines whether the current location of the mobile terminal 20 is within the detection range of the nearest target store. When the determination in step S13 is negative (i.e., when the current location is beyond the detection range), the process is returned to step S11. When the determination in step S13 is affirmative (i.e., when the current location falls within the detection range), the process is advanced to step S14.

In step S14, the processor 21 enables the signal receiver 26. That is, since the current location of the mobile terminal 20 and the target store location are used to detect that the mobile terminal 20 has approached the target store, the processor 21 enables the signal receiver 26 in the disabled state. This activates the signal receiver 26 such that it can receive signals.

In step S15, the processor 21 determines whether the signal receiver 26 has received a signal, for example, in a second predetermined interval. The second predetermined interval may be the same as or different from the first predetermined interval.

The signal received in step S15 may be a signal transmitted from the signal transmitter 51 or may be a distinctive sound emitted within the registered store, which is received by the microphone of the mobile terminal 20. Examples of the sounds emitted within the store may include, but are not limited to, entry chimes, music broadcast inside the store, or sounds generated by cash registers.

The sound produced by a cash register can be a “beep” sound produced when a product code is scanned or a “chime” sound when the cash drawer opens. In this case, the cash register is used as the signal transmitter 51. Sounds may be emitted from the store terminal 18. In this case, the store terminal 18 is used as the signal transmitter 51.

The installation of the signal transmitter 51 allows detection of where the user is located within the store. For example, the mobile terminal 20 detects that the user is relatively near the cash register by receiving a signal transmitted relatively near the cash register. When the microphone of the mobile terminal 20 detects a sound produced by a cash register, the mobile terminal 20 can also detect that the user is relatively near the cash register. Additionally, the mobile terminal 20 detects that the user has entered the store by receiving a signal transmitted relatively near the entrance.

The signal transmitter 51 may be located at a different location depending on the launch target app. For example, a signal may be emitted relatively near the cash register for the payment app and the point app. A signal may be emitted relatively near the entrance for the check-in app.

When the determination in step S15 is affirmative, the processor 21 advances to step S16 to determine whether the mobile terminal 20 is powered on. The processor 21 may determine that the mobile terminal 20 is powered on when, for example, the display 24 is on. Alternatively, the processor 21 may determine that the mobile terminal 20 is powered on when the display 24 is on and unlocked.

When the determination in step S16 is affirmative (i.e., when the mobile terminal 20 is powered on), the processor 21 proceeds to step S17 to launch the launch target app. In other words, when the signal receiver 26 receives a signal transmitted within the target store, the processor 21 automatically launches the app.

When the pay app is used, the processor 21 may determine the initial screen to be opened upon an automatic launch of the application in step S17, based on the store information of the target store. For example, when the target store is a point program-participating store, the point management screen 42 may be displayed. When the target store is an electronic payment-enabled store, the payment screen 41 may be displayed. When the store is a point program-participating store and an electronic payment-enabled store, the processor 21 should display the point management screen 42 upon an automatic launch of the application. This is because the point management screen 42 typically needs to be presented before the payment is completed.

When the point app is used, the processor 21 may display the point management screen (code display screen) 42 upon an automatic launch of the application. When the check-in app is used, the processor 21 may display the detection screen upon an automatic launch of the application.

When the determination in step S16 is negative, the processor 21 advances to step S18 to configure the app launch setting. The app launch setting refers to configuring an automatic launch setting of the app such that the app launches automatically when the mobile terminal 20 is powered on by the user. As a result, when the user manually powers on the mobile terminal 20 after configuring the launch setting, the app launches automatically. The app screen opened in this step is the same as the screen opened in step S17.

After step S17 or step S18, the process is advanced to step S19. In this step, the processor 21 disables the signal receiver 26. That is, after achieving the objective of automatically launching the app, the processor 21 turns off the signal receiver 26 to reduce the power consumption of the mobile terminal 20.

In step S20, the processor 21 determines whether the automatic launch setting for the app is enabled. When the determination in step S20 is negative (i.e., the automatic launch setting for the app is disabled), the processor 21 terminates the process. When the determination in step S20 is affirmative, the processor 21 returns to step S11.

Subsequent to returning from step S20 to step S11, when the target store detected in step S13 is the same as the target store detected in the previous step S13, the enabling of the signal receiver 26 may be avoided until the user leaves the detection range of that target store. This is because if the app is repeatedly launched until the user leaves the target store after the use of the app, it can make the user feel annoyed.

When the determination in step S15 is negative (i.e., when the signal receiver 26 has not received a signal within the store), the process may be advanced to step S21. In this step, the processor 21 may determine whether a stop condition is satisfied. The stop condition is set to determine whether to terminate the determination in step S15.

The stop condition may include, for example, a condition in which the execution count of step S15 is greater than a count threshold. The stop condition may include a condition in which an elapsed time since the enabling of the signal receiver 26 is greater than a time threshold and include a condition in which the distance between the mobile terminal 20 and the store is greater than a distance threshold. The distance threshold may be the same as the detection range that causes the enabling of the signal receiver 26 when, for example, the mobile terminal 20 approaches the target store. For example, when the user approaches the store but leaves without entering the store, the execution count of step S15 exceeds the distance threshold.

Thresholds related to the stop condition, such as count threshold, time threshold, or distance threshold, may be the same across all stores, may differ between the target stores, or may vary depending on the app. Each threshold may be set according to the type of the target store or its floor area. The threshold for each target store may be stored in the database 17 as part of the store information.

For example, the threshold (particularly, count threshold or time threshold) for a store where customers generally spend a relatively long time (e.g., a bookstore or a restaurant) may be greater than the threshold for a store where customers generally spend a relatively short time (e.g., a convenience store). Alternatively, the threshold for a store with a relatively large floor area (e.g., a large-scale commercial facility) may be greater than the threshold for a store with a relatively small floor area (e.g., a convenience store).

As another option, the threshold (particularly, count threshold or time threshold) of the point app and the pay app may be greater than the threshold of the check-in app. This is because users of the check-in app frequently perform check-in operations shortly after arriving at a store whereas the point app and the payment app are often used before exiting the store.

When the determination in step S21 is negative, the processor 21 may return to step S15. When the determination in step S21 is affirmative, the processor 21 may proceed to step S19 and disable the signal receiver 26. That is, in a case in which the signal receiver 26 has not received a signal by the time the stop condition is satisfied after the enabling of the signal receiver 26, the signal receiver 26 may be disabled. This is because if the signal receiver 26 continues to operate without receiving a signal, it will result in excessive power consumption of the mobile terminal 20.

### Operation of Present Disclosure

Mobile terminals that are commercially available on the market are equipped with multiple features as standard. The features included as standard are, for example, a mobile communication feature, a Bluetooth signal reception feature, a GPS feature, and a microphone. The GPS feature is provided by the location sensor 28. The signal reception feature is provided by the signal receiver 26.

After a user purchases a mobile terminal 20, the applications that the user installs can utilize these features included as standard. For example, a pay app for code-based payment utilizes mobile communication features to communicate with the payment server 12. The check-in app displays the list screen 53 by utilizing the GPS feature to obtain the current location of the mobile terminal 20.

In the method for launching the application of the present disclosure, when it is detected using a satellite positioning system that the mobile terminal 20 has approached a store, the launch program enables the signal reception feature of the mobile terminal 20 that has been disabled. Subsequently, when a signal that is transmitted within the store is received by the signal reception feature, the application installed on the mobile terminal 20 is launched automatically.

Generally, the GPS feature utilizing the satellite positioning system has a lower detection accuracy than the detection accuracy in the signal reception feature. To solve this problem, in the launch method of the present disclosure, the GPS feature first detects that the mobile terminal 20 has approached the store, thereby enabling the signal reception feature. Subsequently, the signal reception feature receives signals to detect the user's precise location within the store (e.g., being in front of the cash register). Then, upon receipt of the signal, the launch program automatically launches the application installed on the mobile terminal 20.

In this manner, the launch program utilizes the standard features installed on the mobile terminal 20 to automatically launch one or more applications at the time when the user uses the app. This simplifies manual operations of applications installed on the mobile terminal 20. Further, the launch program reminds the user to use the application and notifies the user that the store is a target store for the corresponding service. Furthermore, the launch program allows application providers to encourage the user to use their services.

### Advantages of Present Disclosure

The present disclosure has the following advantages.
(1) When the mobile terminal 20 approaches a store, the signal reception feature is enabled. When the user enters the target store carrying the mobile terminal 20, the mobile terminal 20 receives a signal that is transmitted within the target store. When the mobile terminal 20 receives the signal, the launch program automatically launches the application. This eliminates the need for users to manually launch the application, thereby simplifying the user's manual operations.
(2) If a signal is received by the mobile terminal 20 while it is inactive, the launch setting for the application is configured. In this case, when the user activates the mobile terminal 20, the application launches automatically. This eliminates the need for users to manually launch the application.
(3) Audio signals, ultrasonic signals, and short-range wireless signals cannot be received by the mobile terminal 20 when it is beyond a target store. However, upon entering the detection range of these signals inside the target store, the mobile terminal 20 becomes capable of receiving the signals. Thus, the installation of the signal transmitter 51 relatively near the cash register allows the application to launch automatically when the user moves to the front of the cash register.
(4) In a case in which the audio signal generated from the cash register is a sound produced by a cash register, the application can be automatically launched when the user moves to the front of the register. Moreover, since the signal transmitter 51 can be replaced by the cash register, there is no need to install an additional device for signal transmission. Further, the mobile terminal 20 receives signals using the microphone included as standard, eliminating the need to install an additional program to receive the signals.
(5) At a point program-participating store, the point management screen 42 is displayed upon an automatic launch of the application. This eliminates the need for users to manually open the point management screen 42 and eliminates the need for users to carry a loyalty card. At an electronic payment-enabled store, the payment screen 41 is displayed upon an automatic launch of the application. This eliminates the need for users to manually open the payment screen 41. This also eliminates the need for users to check, at the time of payment, whether the store is a point program-participating store or an electronic payment-enabled store.
(6) When the store is a point program-participating store and an electronic payment-enabled store, the point management screen 42 is displayed upon an automatic launch of the application. This eliminates the need for users to carry a loyalty card. Further, when the user wishes to make an electronic payment, he can switch to the payment screen 41 by operating the tab 43.
(7) The mobile terminal 20 obtains the store information of a target store from the geographic information server 14. The store information includes information indicating whether the target store is a point program-participating store and information indicating whether the target store is an electronic payment-enabled store. Thus, when the application launches automatically, an appropriate screen, either the point management screen 42 or the payment screen 41, opens according to the target store.
(8) The code display screen 41 or 42 is displayed upon an automatic launch of the application. This eliminates the need for users to open the code display screen 41 or 42 when using services that involve scanning a code.
(9) In a case in which the mobile terminal 20 has not received a signal by the time the stop condition is satisfied, the signal receiver 26 is disabled automatically. This reduces the power consumption that would result from continuous operation of the signal receiver 26.
(10) When the elapsed time since the enabling of the signal receiver 26 exceeds the time threshold, the mobile terminal 20 automatically disables the signal receiver 26. This reduces the power consumption that would result from continuous operation of the signal receiver 26.
(11) When the distance between the current location of the mobile terminal 20 and the store exceeds the distance threshold with no signal received, the mobile terminal 20 automatically disables the signal receiver 26. This reduces the power consumption that would result from continuous operation of the signal receiver 26 when, for example, users do not enter the store.

### Modifications

The present embodiment may be modified as follows. The present embodiment and the following modifications can be combined as long as they remain technically consistent with each other.

### First Modification

The launch target app may be a membership application provided by a business entity or a store. The member application may be configured to display, for example, access information for stores, user identification information, business hours, advertisements, or discount coupons.

### Second Modification

Target stores are not limited to those registered with the check-in service, but may also include standalone stores that independently perform customer visit detection. The purpose of check-in is not limited to the offering of rewards. For example, check-in may also serve to provide services to each of the users based on their usage history.

### Third Modification

The server that sends store information to the mobile terminal 20 in step S11 is not limited to the geographic information server 14. For example, if the launch program is included in the check-in app, the check-in server 15 may send the store information to the mobile terminal 20. If the launch program is included in the pay app, the payment server 12 may send the store information to the mobile terminal 20. If the launch program is included in the point app, the point management server 13 may send the store information to the mobile terminal 20. Alternatively, the data server 16 may send the store information to the mobile terminal 20. In step S13, any of the servers 12 to 16 may determine whether a store is proximate to the mobile terminal 20 by obtaining the current location of the mobile terminal 20, and then send the result of this determination to the mobile terminal 20.

### Fourth Modification

The signal transmitter 51 may also serve as a signal transmitter 51 installed for check-in services or other services. Alternatively, a new signal transmitter 51 may be installed for the launch system 11 of the present disclosure.

### Fifth Modification

When receiving sounds similar to sounds produced by a cash register via the microphone, the launch system 11 does not have to include the signal transmitter 51.

### Sixth Modification

With the installation of an application, one or more types of store information data may be stored in the memory 22 of the mobile terminal 20. In this case, the mobile terminal 20 can obtain store information from the memory 22, instead of obtaining the store information from the servers 12 to 16. In this case, the launch system 11 does not have to include the servers 12 to 16 that send store information to the mobile terminal 20.

### Seventh Modification

The launch target app may be any application that displays a code display screen. For example, the identification code included in the code display screen may be an identification code used for the distribution of coupons. The identification code does not have to be a user code for identifying the user. The identification code may be an identification code used for access management as an electronic ticket. For example, if the identification code is used for access management, the signal transmitter 51 may be placed at a location such as the entrance of a building or the gate of a plaza, which serves as an access point. In this instance, the term “store” in the present disclosure may be replaced with “facility.”

### Eighth Modification

Even if the determination in step S13 is affirmative, the enabling of the signal receiver 26 in step S14 may be suspended based on a predetermined suspension condition. Examples of the suspension condition may include a condition in which the battery capacity of the mobile terminal 20 is below a predetermined value and include a condition in which the signal receiver 26 is being used. When the signal receiver 26 is being used, for example, a voice call is being made using a microphone.

### Ninth Modification

Even if the determination in step S15 is affirmative, the execution of step S17 or step S18 may be suspended based on a predetermined suspension condition. Examples of the suspension condition may include a condition in which the battery capacity of the mobile terminal 20 is below a predetermined value. The suspension condition in step S17 may include a condition in which a user is using another application. This is because when the user does not intend to use the launch target app, the unintended launch of the launch target app while using another application can make the user annoyed. Alternatively, the suspension condition in step S17 may include a condition in which the target store is located in a certain type of facility, such as a quiet place (e.g., a hospital or an art museum).

### Tenth Modification

In the system, method, or program of the present disclosure, a notification for launching an application may be issued instead of automatically launching the application. The notification may be, for example, a message display or a notification by vibration or sound. In this case, the launch system, launch method, and launch program may each be replaced with the notification system, notification method, and notification program, respectively.

### Clauses

Concepts that can be understood from each of the above-described embodiment and modifications will now be described.

### Clause 1

A program for launching an application installed on a mobile terminal, where
the mobile terminal includes a location information processor configured to acquire a current location of the mobile terminal and a signal receiver configured to receive a signal, the signal receiver being switchable between an enabled state and a disabled state, the program including:
   an instruction of acquiring the current location of the mobile terminal;
   an instruction of acquiring store information related to a store, the store information including a store location;
   an instruction of, upon detecting that the mobile terminal has approached the store based on the store location and the current location, enabling the signal receiver in the disabled state; and
   an instruction of, when the signal receiver receives the signal that is transmitted within the store, automatically launching the application.

### Clause 2

The program according to clause 1, where
the automatically launching the application includes configuring a launch setting for the application when the mobile terminal is inactive, where the application launches automatically when the mobile terminal is activated after the launch setting.

### Clause 3

The program according to clause 1 or 2, where
the signal includes at least one of an audio signal, an ultrasonic signal, and a short-range wireless signal.

### Clause 4

The program according to clause 3, where
the signal receiver is a microphone built into the mobile terminal as a standard feature, and
the audio signal includes a sound produced by a cash register.

### Clause 5

The program according to any one of clauses 1 to 4, where
the application is a payment application capable of switching between a point management screen for handling points in a point program and a payment screen for performing a payment process,
when the store is a point program-participating store, the point management screen is displayed upon an automatic launch of the application, and
when the store is an electronic payment-enabled store, the payment screen is displayed upon an automatic launch of the application.

### Clause 6

The program according to clause 5, where
when the store is a point program-participating store and an electronic payment-enabled store, the point management screen is displayed upon an automatic launch of the application.

### Clause 7

The program according to clause 5 or 6, where
the store information includes information indicating whether the store is a point program-participating store and information indicating whether the store is an electronic payment-enabled store.

### Clause 8

The program according to any one of clauses 1 to 7, where
the application is configured to display a code display screen that includes an identification code, and
the code display screen is displayed upon an automatic launch of the application.

### Clause 9

The program according to any one of clauses 1 to 8, further including:
disabling the signal receiver in a case in which the signal receiver has not received the signal by a time a stop condition is satisfied after the enabling of the signal receiver.

### Clause 10

The program according to clause 9, where
the stop condition includes a condition in which an elapsed time after the enabling of the signal receiver is greater than a time threshold.

### Clause 11

The program according to clause 9 or 10, where
the stop condition includes a condition in which a distance between the current location and the store is greater than a distance threshold, and
the distance threshold is a distance at which the signal receiver is enabled when the mobile terminal approaches the store.

### Clause 12

A launch system, including:
a signal transmitter configured to transmit a signal within a store;
a mobile terminal with an application installed, the mobile terminal including a location information processor configured to acquire a current location of the mobile terminal and a signal receiver configured to receive the signal; and
a server configured to send store information related to the store to the mobile terminal, the store information including a store location, where
the mobile terminal is configured to execute:
   acquiring the current location using the location information processor;
   acquiring the store information through communication with the server;
   upon detecting that the mobile terminal has approached the store based on the store location and the current location, enabling the signal receiver in a disabled state; and
   when the signal receiver receives the signal within the store, automatically launching the application.

### Clause 13

A mobile terminal, including:
one or more processors;
one or more memories, the one or more memories storing an application and a launch program for launching the application;
a location information processor configured to acquire a current location of the mobile terminal; and
a signal receiver configured to receive a signal, the signal receiver being switchable between an enabled state and a disabled state,
the launch program is configured to be executed by the one or more processors, and
the launch program includes:
   an instruction of acquiring the current location of the mobile terminal;
   an instruction of acquiring store information related to a store, the store information including a store location;
   an instruction of, upon detecting that the mobile terminal has approached the store based on the store location and the current location, enabling the signal receiver in the disabled state; and
   an instruction of, when the signal receiver receives the signal that is transmitted within the store, automatically launching the application.

### Clause 14

A method for launching an application, the method comprising:
upon detecting that a mobile terminal has approached a store using a satellite positioning system, enabling a signal reception feature of the mobile terminal in a disabled state; and
when a signal that is transmitted within the store is received by the signal reception feature, automatically launching an application installed on the mobile terminal.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for launching an application installed on a mobile terminal, wherein
the mobile terminal includes a location sensor configured to acquire a current location of the mobile terminal and a signal receiver configured to receive a signal, the signal receiver being switchable between an enabled state and a disabled state, the method comprising:
acquiring the current location of the mobile terminal;
acquiring store information related to a store, the store information including a store location;
upon detecting that the mobile terminal has approached the store based on the store location and the current location, enabling the signal receiver in the disabled state; and
when the signal receiver receives the signal that is transmitted within the store, automatically launching the application.

2. The method according to claim 1, wherein
the automatically launching the application includes configuring a launch setting for the application when the mobile terminal is inactive, wherein the application launches automatically when the mobile terminal is activated after the launch setting.

3. The method according to claim 1, wherein
the signal includes at least one of an audio signal, an ultrasonic signal, and a short-range wireless signal.

4. The method according to claim 3, wherein
the signal receiver is a microphone built into the mobile terminal as a standard feature, and
the audio signal includes a sound produced by a cash register.

5. The method according to claim 1, wherein
the application is a payment application capable of switching between a point management screen for handling points in a point program and a payment screen for performing a payment process,
when the store is a point program-participating store, the point management screen is displayed upon an automatic launch of the application, and
when the store is an electronic payment-enabled store, the payment screen is displayed upon an automatic launch of the application.

6. The method according to claim 5, wherein
when the store is a point program-participating store and an electronic payment-enabled store, the point management screen is displayed upon an automatic launch of the application.

7. The method according to claim 5, wherein
the store information includes information indicating whether the store is a point program-participating store and information indicating whether the store is an electronic payment-enabled store.

8. The method according to claim 1, wherein
the application is configured to display a code display screen that includes an identification code, and
the code display screen is displayed upon an automatic launch of the application.

9. The method according to claim 1, further comprising:
disabling the signal receiver in a case in which the signal receiver has not received the signal by a time a stop condition is satisfied after the enabling of the signal receiver.

10. The method according to claim 9, wherein
the stop condition includes a condition in which an elapsed time after the enabling of the signal receiver is greater than a time threshold.

11. The method according to claim 9, wherein
the stop condition includes a condition in which a distance between the current location and the store is greater than a distance threshold, and
the distance threshold is a distance at which the signal receiver is enabled when the mobile terminal approaches the store.

12. A launch system, comprising:
a signal transmitter configured to transmit a signal within a store;
a mobile terminal with an application installed, the mobile terminal including a location sensor configured to acquire a current location of the mobile terminal and a signal receiver configured to receive the signal; and
a server configured to send store information related to the store to the mobile terminal, the store information including a store location, wherein
the mobile terminal is configured to execute:
acquiring the current location using the location sensor;
acquiring the store information through communication with the server;
upon detecting that the mobile terminal has approached the store based on the store location and the current location, enabling the signal receiver in a disabled state; and
when the signal receiver receives the signal within the store, automatically launching the application.

13. A non-transitory computer-readable medium storing a launch program code for launching an application installed on a mobile terminal, wherein the mobile terminal includes a location sensor configured to acquire a current location of the mobile terminal and a signal receiver configured to receive a signal, the signal receiver being switchable between an enabled state and a disabled state, the launch program code comprising:
current location acquisition code configured to acquire the current location of the mobile terminal;
store information acquisition code configured to acquire store information related to a store, the store information including a store location;
enabling code configured to, upon detecting that the mobile terminal has approached the store based on the store location and the current location, enable the signal receiver in the disabled state; and
automatic launch code configured to, when the signal receiver receives the signal that is transmitted within the store, automatically launch the application.
